(19) United States
(12) Patent Application Publication
(10) Pub. No.: US 2014/0243051 A1
(43) Pub. Date: Aug. 28, 2014

(54) Cell Phone Case

(71) Applicant: Natorsha S. Hooks Griffin, Hesperia, CA (US)

(72) Inventor: Natorsha S. Hooks Griffin, Hesperia, CA (US)

(21) Appl. No.: 14/184,712

(22) Filed: Feb. 20, 2014

Related U.S. Application Data
(60) Provisional application No. 61/769,218, filed on Feb. 26, 2013.

(51) Int. Cl. H04B 1/38

(52) U.S. Cl. CPC H04B 1/385; H04B 2001/3855
USPC 455/575.6

(57) ABSTRACT

The invention provides a device for holding a cell phone in a “hands free” configuration so that the user can talk and listen to the cell phone without using hands to hold the cell phone. The device includes attachment means for holding a cell phone on the shoulder, upper arm, or waist of a user. Also provided is a means for holding the cell phone case to a seat belt strap.

### CLAIM OF PRIORITY

This patent application claims priority under 35 USC 119 (e)(1) from U.S. Provisional Patent Application Ser. No. 61/769,218 filed Feb. 26, 2013, of common inventorship herewith entitled, “Cellphone Case.”

### BACKGROUND OF THE INVENTION

1. Field of the Invention

This invention relates generally to a cell phone case and, more particularly, the invention relates to a cell phone case attachable to a seat belt strap or wearable configuration such as should strap, or belt providing a simple and effective means of making their phone “hands-free for use while driving and other activities thus making them safer while relieving them of the need to hold the phone for long periods of time.

2. Description of the Prior Art

More than 86 percent of the US population, i.e., more than 285 million people, now use and rely upon cell phones not only for near-constant business and personal communication, but also for surfing the Internet, reading the news, playing video games, texting, and watching videos. Cell phones, without doubt, have affected an enormous, worldwide revolution in personal communications. But cell phones, like everything else, have their drawbacks. For one thing, while we all appreciate the instant, portable, on-the-go convenience that our cells give us, all those minutes we rack up each month are also minutes that we're holding the phone up to our ear: And that's a serious, sometimes illegal and potentially even fatal, problem. Texting while driving may be the biggest danger on our roadways today, but just talking on a handheld cell phone is illegal in some states, and is an unsafe practice whether legal or not. A growing number of states restrict cell phone use while driving to the use of “hands-free” devices. And while a lot of cell phone users may employ Bluetooth-enabled, hands-free headsets, many millions more do not.

### BRIEF DESCRIPTION OF THE DRAWINGS

FIGS. 1-7 are perspective views illustrating a cell phone case, constructed in accordance with the present invention.

### SUMMARY OF THE INVENTION

It is an object of the present invention to provide a device for holding a cell phone in a “hands free” configuration so that the user can talk and listen to the cell phone without using hands to hold the cell phone.

It is a further object of the present invention to provide a device for holding a cell phone in a “hands free” configuration wherein the device is mounted to the shoulder or upper arm of the user.

It is still further object of the present invention to provide a device for holding a cell phone in a “hands free” configuration wherein the device is mounted to a seatbelt strap.

It is a still further object of the present invention to provide a device for holding a cell phone on a belt for wearing around the waist or midsection of the user.

### DETAILED DESCRIPTION OF THE PREFERRED EMBODIMENTS

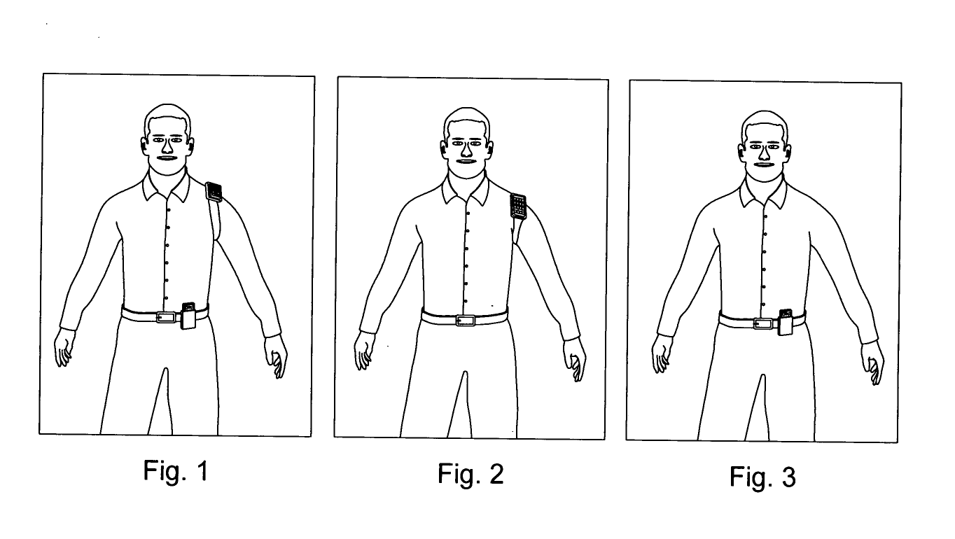

As illustrated in FIG. 1, the present invention is a cell phone case providing a simple and effective means of making their phone “hands-free” for use while driving and other activities thus making them safer while relieving them of the need to hold the phone for long periods of time.

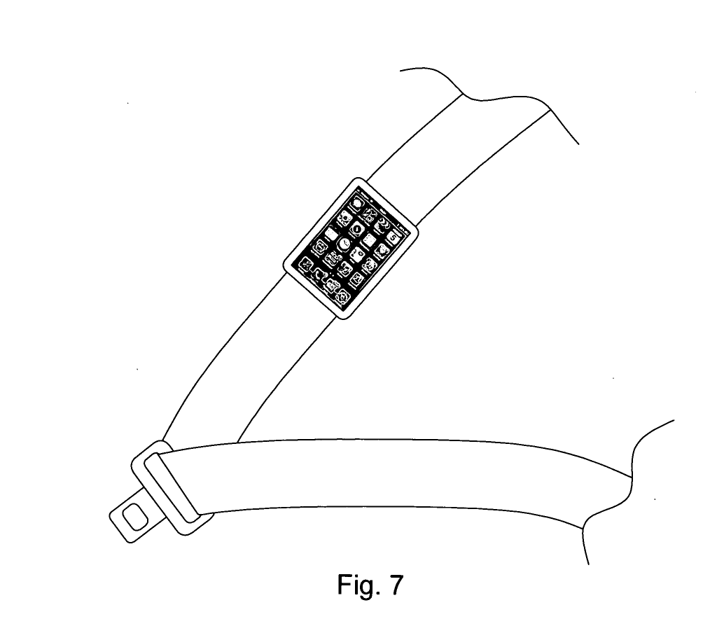

The cell phone case of the present invention is designed to fasten comfortably but securely to the wearer's shoulder (FIGS. 1, 2) arm, or waist (FIG. 3), and can attach to the seatbelt (FIG. 7) enabling the wearer to enjoy hands-free cell phone communications or entertainment via their cell's speakerphone mode. The cell phone case features two basic designs. Each of the two basic designs can be produced in a variety of materials ranging from fine leather to synthetic, elasticized fabrics to rigid or flexible, injection-molded thermoplastics. And each of the two basic designs can be produced in a tremendous variety of colors and patterns, from a clear transparent version to black, red, pink, blue, green, and other popular colors; and each can be embellished with a variety of accents such as glitter, sequins, beads, and so forth. The user chooses not only which of the two basic designs best suits their needs, but whether they would prefer the case in leather or elastic, hot pink or leopard spots, with sequins or sunbursts or with a glossy or matte finish.

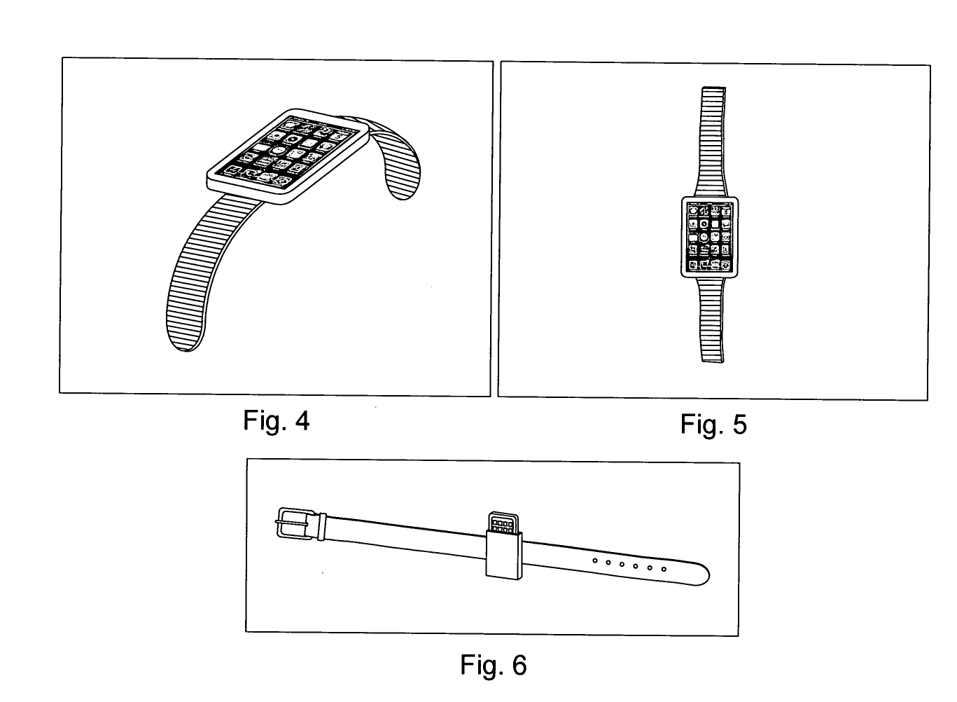

The two basic versions of the cell phone case of the present invention is a sheath-style, form-fitting cell phone case, with perforated openings over the phone's speaker and microphone. The case opens and closes with fastening snaps or VELCRO®. (Since cell phones differ in regard to the placement of speaker and microphone, the cell phone case can also be demarcated by the brand of phone to be accommodated: the line would offer specific models for iPhone®; BlackBerry®; and Android®, for example.) Other than the stylistic variations discussed above, the two basic versions of the case differ in the manner of their fastening or mounting to the wearer's clothing, or seatbelt as follows:
1) FIGS. 1 and 2 show a shoulder-mounted case fastens securely to the user's shoulder or upper arm. Alternately, the case can attach to the seatbelt, as shown in FIG. 7. Both positions place the (speakerphone-mode) cell phone close enough to the face for hands-free communication or listening. As shown in FIG. 4, the case can also be configured to clamp over one's shoulder with a pair of cushioned, tensioned clamping arms similar to those of a molded hair-band. FIGS. 1 and 2, show the device able to fasten over one's shoulder with single or double, adjustable elastic or VELCRO®-fastening straps. Either approach will secure the phone conveniently for easy, hands-free use.
2) FIG. 6 shows a waist-belt case secures the cell phone holder to a stylish belt that can be produced in a narrow or wide version. This is shown in FIG. 6. FIG. 3 shows a person wearing the cell belt of FIG. 6. The cell phone case or holder can be positioned and secured at any point along the belt; and the belt itself can be produced in a wide variety of materials, patterns, styles, and colors. Although the waist-belt will obviously not bring the phone as close to the wearer's face as the shoulder-mounted version, the belt might be the perfect choice as an accessory for some users: for example, a walker who wishes to listen to music while walking.
3) The case presents itself as a product concept with substantial potential and an almost limitless range of styling decisions and choices.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

1. A device for holding a cell phone in proximity to a user to permit use of the cell phone without holding the cell phone in hand comprising: a sheath-style, form-fitting cell phone case, wherein the case has perforated openings over the area covering a phone speaker and microphone, further wherein the case opens and closes with fastening snaps or hook and loop fasteners, further comprising means for attaching the case to a strap.

2. The device of claim 1 wherein the strap is configured to fit over a user's shoulder.

3. The device of claim 1 wherein the strap is configured to fit over a user's upper arm.

4. The device of claim 1 wherein the strap is configured to fit over a seat belt shoulder strap.

5. The device of claim 1 wherein the strap is configured to fit over a belt.

6. The device of claim 5 wherein the belt is worn around a user's waist or midsection.

7. The device of claim 1 wherein the device is produced in any of a variety of materials including, but not limited to fine leather, fabric, plastic, elasticized fabric, flexible material, rigid material, and injection-molded thermoplastics.

8. The device of claim 7 wherein the device produced in a any of a variety of colors and patterns, including, but not limited to clear transparent, black, red, pink, blue, green, and other popular colors; and further wherein the device can be embellished with one or more embellishment accent including glitter, sequins, beads, and rhinestones or any other embellishment.

9. The device of claim 1 wherein the strap is configured to fit over a pair of cushioned, tensioned clamping arms similar to those of a molded hair-band.

10. The device of claim 6 wherein the case can be positioned and secured at any point along the belt.

11. The device of claim 5 wherein belt can be produced in any of a wide variety of materials, patterns, styles, and colors.
